(19) United States
(12) Patent Application Publication
(10) Pub. No.: US 2013/0091274 A1
(43) Pub. Date: Apr. 11, 2013

(54) Process for Monitoring, Analyzing, and Alerting an Adult of a Ward's Activity on a Personal Electronic Device (PED)

(71) Applicant: Family Signal, LLC, Dearborn, MI (US)

(72) Inventors: Matthew Jamison Fanto, Dearborn, MI (US); Brian Michael Eisenberg, Bloomfield Hills, MI (US); Matthew Owen Warner, Dearborn, MI (US); Brandon Nicholas Gheen, Ypsilanti, MI (US)

(73) Assignee: FAMILY SIGNAL, LLC, Dearborn, MI (US)

(21) Appl. No.: 13/645,618

(22) Filed: Oct. 5, 2012

Related U.S. Application Data
(60) Provisional application No. 61/640,880.
(60) Provisional application No. 61/543,912, filed on Oct. 6, 2011.

(51) Int. Cl. G06F 15/173

(52) U.S. Cl. 709/224

(57) ABSTRACT

A process comprising monitoring certain defined activities of a first party and alerting a second party of these activities; said monitoring performed by providing a web service for the second party; scanning a first user's electronic accounts; detecting defined activities; and sending at least one of a text and email notification to the second party if any dangerous messages are detected.

### FIELD OF THE INVENTION

The present teaching relates to a process for monitoring and alerting a responsible second party of the activities of a first party.

### BACKGROUND OF THE INVENTION

In the fast paced world we live in, responsible second parties often find it difficult to find time to monitor the actions of a first party, everyone within his/her care, his/her wards. The children and caregivers of elderly individuals are often concerned about the financial responsibility of the elderly individual. Family members and loved ones of irresponsible adults are often left wondering how they could prevent the further demise of the irresponsible adult. Parents are often left in the dark on what is going on in their child's life until it is too late to do anything about it.

With respect to the parent child relationship, with widespread access to Personal Electronic Devices (PEDs), online corresponding has become an important aspect to a child's social life. Twenty-nine percent (29%) of teens say they have had at least one frightening experience online. Twelve percent (12%) of tweens and fifty-six percent (56%) of teens say they have been asked for their identity information online and more than half (50%) of teens say that a stranger online wanted to meet in person. Alternatively, a child may carelessly publicly post inappropriate information or photos on the internet, including discussions of drugs, alcohol, and sex. The optimum solution for a parent is to create and maintain a close relationship with his/her child to guide them along these tough challenges. The same is true for any relationship between a responsible second part and his/her ward.

When a second party is unable to maintain a close relationship with a first party there is a need for a process that allow a second party to have the monitoring capabilities of first party's actions, that then alerts the second party of any concerning activities including online interactions with a third party to provide an opportunity to address problems and situations as they arise.

### SUMMARY OF THE INVENTION

The present invention provides an adult with the opportunity to monitor activities of a ward online. The invention is directed to a process for monitoring various online activities including, but not limited to: signs of harassment on all of a ward's social networking traffic, including incoming and outgoing comments, messages, status updates and wall posts; what a ward writes if they are the one doing the bullying; potential danger signs related to drugs, alcohol, and sex; and personal information that is provided by the ward to third parties such as home address, phone number and school, for instance. For example, a User may request monitoring a ward's Social Networking account. The User enters the wards email and password. Alternatively, the ward may enter the password to preserve their privacy. The ward's integrated Facebook and Twitter accounts are monitored for activity such as tweets and messages on Twitter as well as messaging, comments, notes and status updates on Facebook. The Program analyzes this data for any signs of danger. If any dangerous activity is detected, the Program instantly sends an alert to the User, notifying the User of the ward's activities. The User can then log into a Website to learn even more about the alert. Three levels of alerts may be generated: a test message to the User, an email to the User, and/or a log of the event on the User's Website dashboard. The alerts are automatically logged to the User's account. The User has the option to receive an alert both a text and email or not at all. Individual alerts include all available content of a conversation to help the User decide if anything dangerous has occurred. The User has the option to re-classify alerts. The step of re-classifying is learned by the Program and applied for weighing future alerts. The User may customize their monitoring needs and levels for each ward, preserving trust with each ward by avoiding constantly monitoring every word and action of each ward and alerting a User to only specified activities.

### DESCRIPTION OF THE DRAWINGS

FIG. 1 illustrates an embodiment of the elements of the process of the present invention.

FIG. 2 illustrates the ability for a guardian to add wards, select the means to be alerted, along with other account settings.

FIG. 3 illustrates a child monitoring registration form

FIG. 4 illustrates the ability for a guardian to select what accounts to monitor of a ward.

FIG. 5 illustrates a second preferred process of the Program of the present invention, including providing alerts on a Personal Electronic Device (PED) in the form of a cell phone Application.

### DESCRIPTION OF THE INVENTION

U.S. Provisional Application Ser. No. 61/543,912 (filed Oct. 6, 2011) and U.S. Provisional Application Ser. No. 61/640,880 (filed May 1, 2012) are hereby incorporated by reference along with any continuations thereof. The explanations and illustration presented herein are intended to acquaint others skilled in the art with the invention, its principles, and its practical application. The specific embodiments of the present invention as set forth are not intended as being exhaustive or limiting. The scope of the invention should be determined with reference to the appended claims, along with the full scope of equivalents to which such claims are entitled. The disclosure of all articles and references, including patent applications and publications, are incorporated by reference for all purposes. Other combinations are also possible as will be gleaned from the following claims, which are also hereby incorporated by reference into this written description.

The process of the invention can be used for monitoring electronic activities of a first party and alerting a responsible second party of these activities. The responsible second party may be a responsible adult in a guardian position, such as a parent, custodian, caregiver, legal guardian, and the like. The first party may be a ward, anyone under the care or supervision of the responsible adult, such as a minor child, an elderly person, irresponsible adult, incompetent adult, and the like. The concerning activities may include, dangerous messages or electronic communications, accessing large sums of money, the sharing of personal information and the like. The wards social networks, electronic mail accounts, other personal electronic accounts and the like which are provided are monitored for the concerning activities.

The process provides a way for a responsible adult to monitor the electronic interactions and communications of his/her ward. In one embodiment the process includes a web service for responsible adults that scans a ward's social networks, electronic mail accounts, other personal electronic accounts provided and the like, and sends text and email notifications to a responsible adult if any dangerous messages are detected. These messages may include references to: drugs, sex, bullying, racism, alcohol, cigarettes, depression, homophobia, profanity, and personal information. Personal information may include a ward's name, address, social security number, bank account information, credit card information and the like. Users may configure the categories monitored. This allows responsible adults to individually control what is and is not appropriate activity for each ward.

The flow of requests and notifications can take place using the internet to transmit information and servers connected to the internet to perform the recited operations. Preferably the server is accessed remotely via the internet. Any software system that facilitates such communication and routing of information and messages may be utilized. In a preferred embodiment the information is transmitted and analyzed using cloud computing. Apple and Microsoft provide systems that work for this purpose, for instance Microsoft Azure cloud computing and Apple I-cloud system. When data is assembled for analysis to determine if a message or post presents concerns as detailed herein, data mining software is utilized to determine if a message should be sent to the responsible adult. Any data mining software package that can work with the server software and perform the analysis may be used, exemplary data mining software useful includes Lighthouse dataminine software.

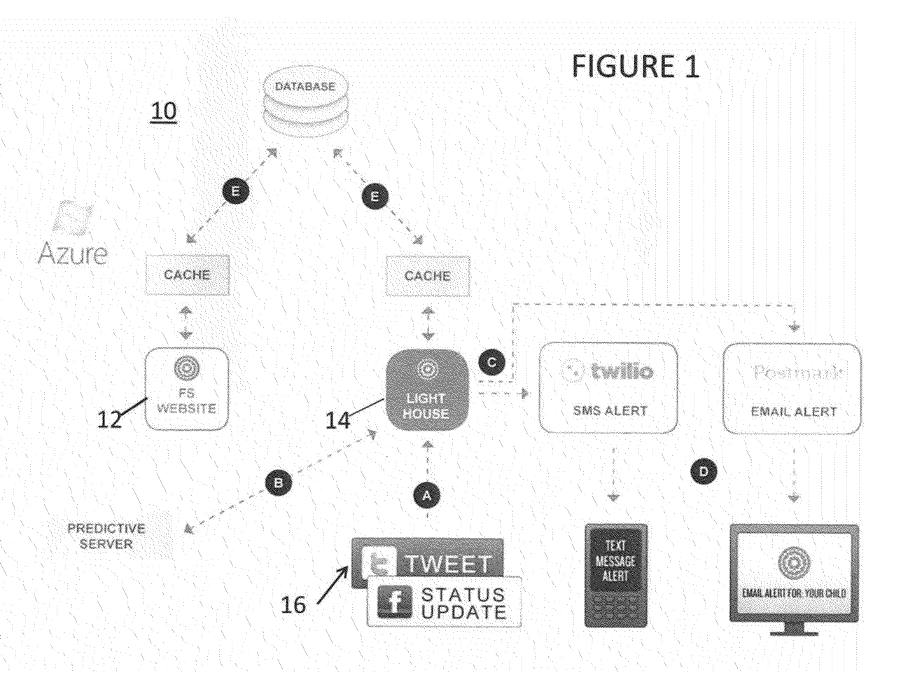

With reference to FIG. 1, the method includes utilizing the Microsoft Azure cloud service 10. The novel monitoring and alerting program (“the Program”) utilizes multiple Azure roles to handle both the website (“Website”) 12, as well as the worker roles (“Lighthouse”) 14 responsible for scanning a ward's data 16. In order to provide services such as text and email alerts, the Program interfaces with external services. The Program architecture is built principally with two components: a Website 12 handles all interactions with the User, including registration, managing alert preferences, and configuring wards to monitor.

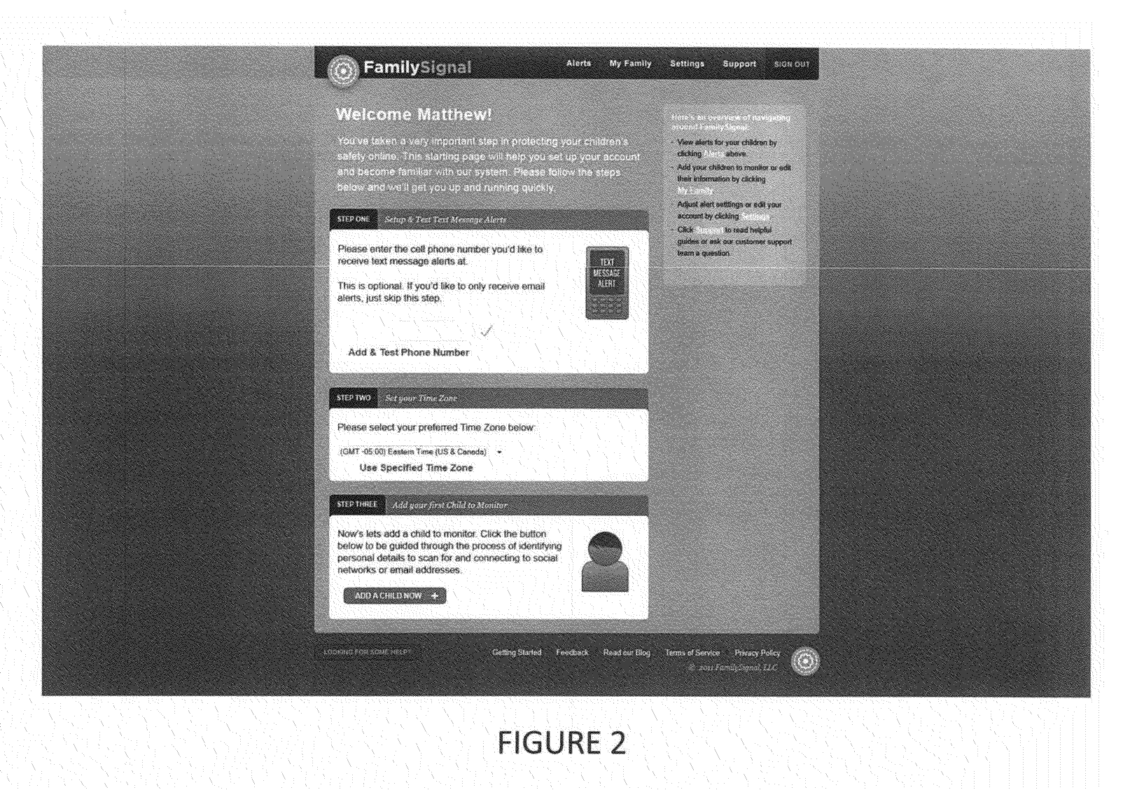

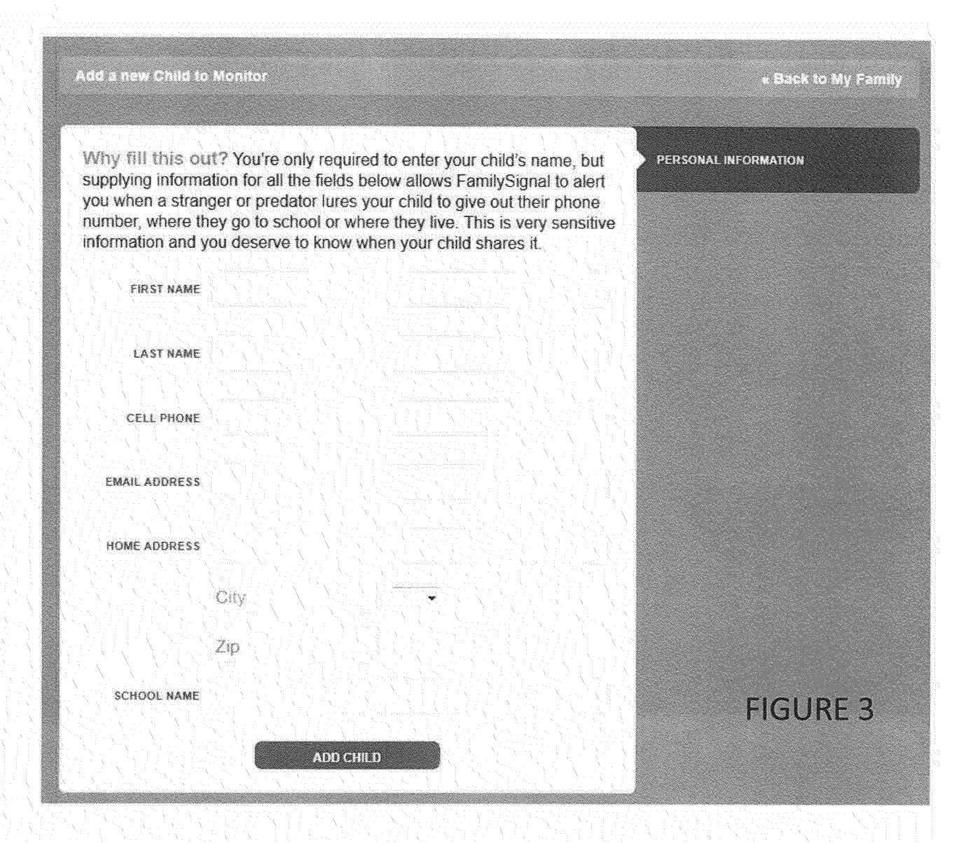

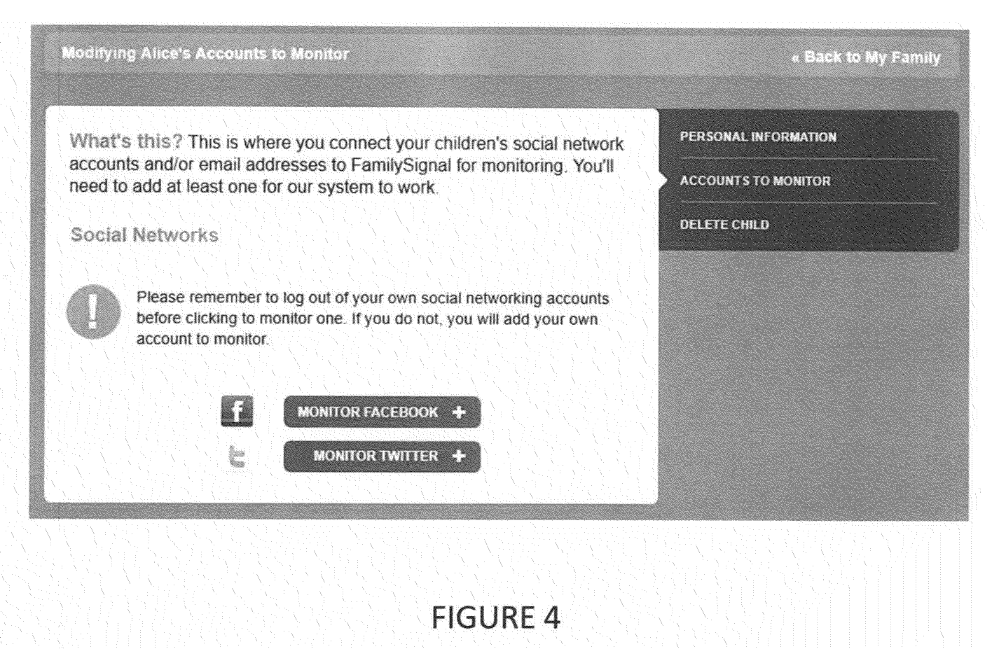

FIGS. 2-4 illustrate the steps of registering a User, such as a parent, for requesting the step of monitoring a ward, such as a ward, and receiving alerts. After a User configures their account via the website, Lighthouse 14 begins to monitor the social network accounts of any ward the User has added. Lighthouse 14 is also responsible for sending alerts to the User. The User may receive alerts on any PED in multiple available formats, such as a cell phone or email. The User enters the appropriate time zone. The User must configure their account to receive text notifications. This step sends a test message to the User, verifying the Program can successfully send messages to the User. After successfully configuring text alerts, the User must add a first ward to monitor. In the next step, the User provides information regarding the ward to be monitored. This step entails providing the personal information of each ward, including full name, address and school attending, in order to detect and alert the User if such personal information is being provided by the ward to a third party. FIG. 4 illustrates a next step and includes the User specifying what electronic accounts, such as social network accounts, of the ward are to be monitored. This step allows the Program to obtain an oauth2 authorization token for the account, which allows a service offline access to all account data.

All processing of a ward's data is done through the service codenamed Lighthouse 14. The Microsoft Azure Worker Role 10 requires a service enter an infinite loop that must never terminate. Lighthouse 14 is principally two components. The first is the infinite loop that schedules a ward for monitoring. The second is the Quartz.NET jobs that handle the monitoring of each individual ward.

The Program implements the Azure Cloud Service 10 as follows:

New Ward Monitoring:

1. Enter the Azure worker loop

2. Check the database or Azure queue for any new ward to be monitored

3. If any new ward has been added via the Website 10, schedule a Quartz.NET job to run every 5 minutes repeating. This Quartz.NET job should maintain a unique identifier of the ward to monitor.

Monitoring Task:

Social Network sites, such as Facebook, Twitter, and the like, do not provide push notification for all data feeds. This means that we must poll Facebook and Twitter periodically for any new data. Care must be taken to ensure the Program does not go over the respected platforms limits.

1. Wake up the Quartz.NET job every 5 minutes—This time interval reasonably falls within all services respected rate limits, while still minimizing the interval in which a ward's account is not being scanned.

2. Query the database for any changes to this ward, including social network accounts added or removed, and updated personal information.
a. Check if the User account is suspended. If it is, return.
b. If the ward has been removed, mark the Quartz.NET job PendingDelete as true, so the scheduler may remove the task.
c. If the ward has not been removed and the account is still valid, move to step 3

3. Scan social networks
a. Read the DateTime the last time each account was scanned. Store this in LastScan.
b. If a ward has a Facebook account to monitor, query Facebook using the Graph API and FQL for any new messages, comments, status updates, wall posts, or news feed items (“messages”) since the LastScan time. If any new messages are detected, scan them using the Classifier.
c. If a ward has a Twitter account to monitor, query Twitter using the Twitter API for any new tweets, direct messages, or mentions. If any messages have been found, scan them using the Classifier.
d. Update the database with the latest scan times, so that during the next iteration, the Program does not scan old data.

4. If any dangerous messages are found in steps 3a or 3b, query the database for the ward's alert preferences. Users may customize the categories for receiving alerts. In this step, the Program compares the category the message was detected as, with the User's preferences.
a. If the dangerous message does not match the alert preferences, the Program will not alert the User and will end this job.
b. If a match, then the Program should alert, go to step 5.

5. Store the information regarding this alert, along with all associated social network data that caused this alert.
a. Store each social network message, including any comments or authorship data in the Microsoft Table Storage. Store each social media message in a unique partition, thus ensuring scalability in the event a single post triggers alerts for many Users.

6. The alert process sends a text message and an email to a User, subject to rate limiting conditions.
a. If the User has received alerts within the past 30 minutes, the Program will not send any alert to the User. This prevents a flood of messages to the User's PED.
b. If the User has not received two alerts within the past 30 minutes, send a text message alert and email alert.

Classifier—The Program classification engine works using a multi-step process:

1. Normalize the input. This step removes extraneous characters, removes formatting, and reduces the message down to just the text. This occurs with the following three steps:
a. Convert the message to all lowercase.
b. Remove all non-alphanumeric characters from the message.
c. Replace abbreviations (‘u’, ‘b4’) and “internet speak” (‘stfu’, ‘lmfao’).

2. Search for any personal information in the normalized message. This step attempts to match any personal information entered in (Image 1) using regular expressions.
a. Generate a regular expression for matching each property, including variations.
b. For example, generate a regular expression to match 3135551212, 313-555-1212, 313 555 1212, 313.555.1212, 5551212, 555-1212, 555.1212, etc.

3. Look for exact words and phrases using regular expressions.
a. This step attempts to find specific words and phrases that are regarded as bad. It is best described as a keyword search using regular expressions.
b. If any exact words or phrases are found, skip to step 4, otherwise go to step 3.

4. Use a Naïve Bayesian Classifier to determine the category of this message. This step uses a multi-category naïve Bayesian classifier to determine probability scores of each of the Program categories (see Categories below). To determine the document category, first evaluate any matched words and phrases from step 2.

5. If any were detected, sum the number of matches for each category, and select the category with the highest number of matches. If no words or phrases were detected in step 2, determine the category simply by the highest probability score from step 3. The probability may automatically be set above a certain threshold for the document to be considered dangerous.

The Classifier requires supervised training in order to make accurate predictions. This includes data mining public internet sources for data relating to any of the classifier categories listed. Some sources for this data include Twitter trends, YouTube comments, various internet forums, Wikipedia articles, government sources, and public domain data sets. Once a suitable amount of training data is found, it is categorized and fed into the Program classifier for training.

Currently, the Program scores documents according to the following categories: Safe: The message contains no discernible dangerous content; Alcohol: Any alcohol or drinking related phrases, including brand names; Drugs: Any drug reference, including data from the White House Office of National Drug Control Policy; Sex: Sex references, including pregnancy, STD's, and general sexuality; Personal: Words and phrases related to sharing personal information, including names, phone numbers, addresses, school information, and other fields from FIG. 1; Cigarettes: References to cigarettes or smoking, including brand names; Bullying: Any threats of violence, hate, racism, homophobia, and insults; Distress: References to suicide and depression; or Profanity: Any profane words.

In an alternative embodiment, supporting the monitoring many wards may require changes to Lighthouse 14. This includes separating Lighthouse into individual Azure roles.

1. Dedicated instance for sending alert notifications.
a. One of the most computationally intensive parts of the operation is sending email and text notifications to the User. This requires connecting to outside services that may not always be available. In the event a service is down, the operation should retry until successfully sending the notification.

2. Utilize a command and control pattern for distributing work across multiple Lighthouse roles. A single instance acts as the master, monitoring for Azure topology changes.
a. The master should keep track of which instances are monitoring which ward.
b. If a new Lighthouse instance is added, the master should send messages to this new instance indicating which ward to be monitored.
c. If a Lighthouse instance is removed, the master should reassign all wards belonging to that instance to other instances. This should take into account the relative workloads of remaining instances.

3. Communicate changes in a ward's status via Queues or Service Bus.

Instead of polling the database each scan for changes to a ward, the Website can communicate these changes via durable messages, thus minimizing impact to the cache and database layers.

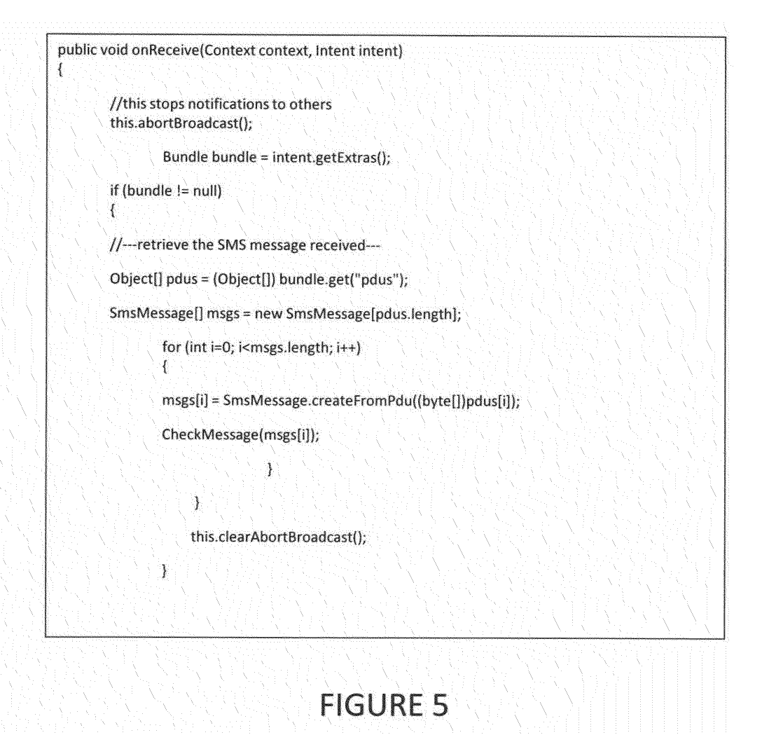

In another alternative embodiment, the Program is an application designed to monitor incoming and outgoing SMS and MMS messages on mobile phones, and alert Users to potentially dangerous content. With reference to FIG. 5, the mobile application runs in the background or is “baked into” the phones' image. Anytime a text message is sent or received an event is raised notifying the application captured, and a web service call is made to the Program service for processing. To prevent a ward from disabling the application, the application may periodically “phone home” to the Program service. The duration between successive calls may be configured to optimize network bandwidth and the window of vulnerability in which a text message could be sent undetected. The application may also notify the web service anytime it stops or is started, ensuring Users have a clear log of the events taken place.

All messages are processed in the following manner.

1. Normalize the message: Remove all extraneous punctuation, symbols, numbers, and other irrelevant characters. Convert the message to a fixed casing.

2. Remove stop words: This step removes high frequency words such as ‘I’, ‘and’, ‘the’, etc. which have little relevance to the underlying meaning, but may affect classification.

3. Search for specific words and phrases: There are some words and phrases for which no ‘safe’ context exists for wards. Perform regex and substring searches for these specific words and phrases.

4. If no specific words or phrases have been found, attempt to classify the message: This performs various statistical document classification process, including Bayesian Classifiers, Latent Sematic Analysis, and sentiment analysis. This process uses training data from a variety of sources.

5. If any specific words were found, or the classifier has indicated the message belongs to any dangerous category, send an alert.

All messages processed by the Program may be optionally saved for later viewing, searching, and analytics.

Categories for alerts are configurable, allowing Users to control on which topics they wish to be notified. For example, one ward may be configured to alert anytime a message with profanity is detected, while an older ward may be configured to ignore profanity. If the message belongs to an ‘unsafe’ category, send an alert to the User according to the User preferences. This includes both email and text notifications, containing either just the category of the message (“An alcohol related message was found for your ward”), or including the entire message itself. Because of the high volume of messages sent in a day, rate limiting may be used to prevent too many alerts from being sent. For example, only 2 alerts will be sent to the User every 1 hour, ensuring timely notification of new issues, while preventing a flood of alerts being generated from a single conversation. Users may also be alerted anytime the application status changes. This includes starts and stops, or anytime the device fails to “phone home”.

Training data may be built from a variety of sources, including public Twitter feeds, Facebook posts, web forum posts, YouTube comments, Wikipedia, and private websites and web filter lists. This data is categorized, and then used to train the statistical classifiers. The training data should be frequently updated, in analytics. Analytics may be shown for messages, including frequency of texting, most frequent topics of conversation, most frequent contact, and other insights.

Any numerical values recited in the above application include all values from the lower value to the upper value in increments of one unit provided that there is a separation of at least 2 units between any lower value and any higher value. As an example, if it stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

1. A process comprising:
monitoring certain defined activities of a first party and alerting a second party of these activities; said monitoring performed by
a. providing a web service for the second party;
b. scanning a first user's electronic accounts;
c. detecting defined activities; and
d. sending at least one of a text and email notification to the second party if any dangerous messages are detected.

2. The process of claim 1, wherein the messages may include references to at least one of: drugs, sex, bullying, racism, alcohol, cigarettes, depression, Homophobia, profanity, or personal information.

3. The process of claim 1, including the step of configuring the categories monitored.

4. The process of claim 3, including the step of the second user controlling each of the first user's electronic accounts.

5. The process of claim 1 further comprising a novel software program for implementing the process for monitoring, analyzing, and alerting an adult of a ward's activity on a personal electronic device (ped).
